(19) United States
(12) Patent Application Publication
(10) Pub. No.: US 2014/0001951 A1
(43) Pub. Date: Jan. 2, 2014

(54) FLEXIBLE DISPLAY APPARATUS AND METHOD OF MANUFACTURING THE SAME

(71) Applicants: Che-Ryong Hwang, Yongin-City (KR); Jae-Wook Kang, Yongin-City (KR); Moo-Jin Kim, Yongin-City (KR); In-Cheol Ko, Yongin-City (KR); Jun-Hyuk Cheon, Yongin-City (KR)

(72) Inventors: Che-Ryong Hwang, Yongin-City (KR); Jae-Wook Kang, Yongin-City (KR); Moo-Jin Kim, Yongin-City (KR); In-Cheol Ko, Yongin-City (KR); Jun-Hyuk Cheon, Yongin-City (KR)

(21) Appl. No.: 13/689,254

(22) Filed: Nov. 29, 2012

(30) Foreign Application Priority Data
Jun. 28, 2012 (KR) 10-2012-0070230

(51) Int. Cl. H05B 33/02; H05B 33/10

(52) U.S. Cl. CPC H05B 33/02; H05B 33/10
USPC 313/511; 445/24

(57) ABSTRACT

A flexible display apparatus and a method of manufacturing the same are disclosed. The flexible display apparatus includes a substrate; a light-emitting display unit formed on a first surface of the substrate; an encapsulation layer formed on the light-emitting display unit; and a conductive layer formed on a second surface of the substrate, the second surface of the substrate being opposite to the first surface of the substrate, wherein the conductive layer includes a conductor, and the conductor includes at least one selected from a carbon nanotube (CNT), fullerene, and a nanowire. Changes in characteristics of the light-emitting display unit due to static electricity are prevented in this configuration.

### CLAIM OF PRIORITY

This application makes reference to, incorporates the same herein, and claims all benefits accruing under 35 U.S.C. §119 from an application for FLEXIBLE DISPLAY APPARATUS AND METHOD OF MANUFACTURING THE SAME earlier filed in the Korean Intellectual Property Office on 28 Jun. 2012 and there duly assigned Serial No. 10-2012-0070230.

### BACKGROUND OF THE INVENTION

1. Field of the Invention

One or more embodiments of the present invention relate to a flexible display apparatus and a method of manufacturing the same.

2. Description of the Related Art

As display-related technology has been developed, flexible display apparatuses that can be folded or rolled in the form of a roll have been studied and developed.

Organic light-emitting display apparatuses have superior characteristics, such as wide viewing angles, excellent contrast, short response times, low power consumption, and the like, and the scope of applications from personal portable devices, such as MP3 players, mobile phones, and the like, to TVs has been enlarged. In addition, organic light-emitting display apparatuses have self light-emitting characteristics and thus do not require an additional light source. As such, their thickness and weight can be reduced.

The organic light-emitting display apparatuses can be implemented as flexible display apparatuses by using a plastic substrate. Generally, flexible organic light-emitting display apparatuses may be manufactured by forming an organic light-emitting device on a carrier substrate formed of material, such as glass or the like, by irradiating laser onto the organic light-emitting device and by separating the carrier substrate from a plastic substrate.

However, when laser is irradiated onto the organic light-emitting device so as to separate the carrier substrate from the plastic substrate, static electricity is generated between the carrier substrate and the plastic substrate. Generated static electricity may cause changes in electrical characteristics of the organic light-emitting device, such as changing a polarity of a voltage generated in a thin film transistor (TFT) into a positive polarity. Thus, the reliability of flexible display devices and stability in driving flexible display devices may be lowered.

### SUMMARY OF THE INVENTION

One or more embodiments of the present invention provide a flexible display apparatus that may prevent changes in characteristics of a light-emitting display unit due to static electricity, and a method of manufacturing the flexible display apparatus.

According to an aspect of the present invention, there is provided a flexible display apparatus including: a substrate; a light-emitting display unit formed on a first surface of the substrate; an encapsulation layer formed on the light-emitting display unit; and a conductive layer formed on a second surface of the substrate, the second surface being opposite to the first surface, the conductive layer comprising a conductor, the conductor comprising at least one of a carbon nanotube (CNT), a fullerene, and a nanowire.

Conductivity is uninterrupted across all dimensions of the conductive layer.

The conductive layer can have a thickness of 10 to 30 μm.

A content of the conductor in the conductive layer can be 5 to 10 wt %.

The flexible display apparatus may further include, on a surface of the conductive layer opposite to that facing the second surface of the substrate, a silane derivative layer having conductivity.

A device and wiring layer may be formed between the substrate and the light-emitting display unit.

The light-emitting display unit may include an organic light-emitting display panel.

According to another aspect of the present invention, there is provided a method of manufacturing a flexible display apparatus, the method comprising: providing a carrier substrate; providing a conductive material; providing a substrate composition, the substrate composition comprising one or more substrate composition components, the substrate composition being capable of forming a substrate layer; providing an organic light-emitting composition, a pixel electrode composition, and an opposite electrode composition; providing an encapsulation composition, the encapsulation composition comprising one or more encapsulation composition components; using the conductive material to form a conductive layer on the carrier substrate; using the substrate composition to form a substrate on the conductive layer; forming a light-emitting display unit on the substrate, the forming step comprising: using the pixel electrode composition to form a pixel electrode layer; using the organic light-emitting composition to form an organic light-emitting layer; and using the opposite electrode composition to form an opposite electrode layer; using the encapsulation composition to form an encapsulation layer on the light-emitting display unit; and removing the carrier substrate from the substrate, the conductive material comprising a conductor, the conductor comprising at least one of a carbon nanotube (CNT), fullerene, and a nanowire.

The conductive layer may be formed by applying a solution including the conductor onto the carrier substrate and by drying and firing the applied solution.

The conductive layer may be formed by forming a paste including the conductor, glass frit, a binder, and a solvent, on the carrier substrate by using a screen printing method.

The carrier substrate may be removed from the substrate by using a physical method.

The conductive layer may have a thickness of 10 to 30 μm.

A content of the conductor in the conductive layer may be 5 to 10 wt %.

The conductive layer may cross the substrate.

An adhesion force between the substrate and the conductive layer may be greater than an adhesion force between the carrier substrate and the conductive layer.

The method may further include forming a silane derivative layer having conductivity on the carrier substrate.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic cross-sectional view of a flexible display apparatus according to an embodiment of the present invention;

FIG. 2 is a schematic cross-sectional view of one pixel region of a display panel unit of the flexible display apparatus illustrated in FIG. 1;

FIGS. 3 through 6 are cross-sectional views illustrating a method of manufacturing the flexible display apparatus of FIG. 1, according to an embodiment of the present invention;

FIGS. 7A and 7B are graphs showing voltage transfer curves before and after a carrier substrate is detached from the flexible display apparatus of FIG. 1, respectively; and

FIGS. 8A and 8B are graphs showing voltage transfer curves of the flexible display apparatus of FIG. 1.

### DETAILED DESCRIPTION OF THE INVENTION

The present invention will now be described more fully with reference to the accompanying drawings, in which exemplary embodiments of the invention are shown.

Elements in the following drawings may be exaggerated, omitted, or schematically illustrated for conveniences and clarity of explanation, and the sizes of elements do not reflect their actual sizes completely.

It will be understood that when an element or layer is referred to as being “on” or “under” another element or layer, the element or layer can be directly on another element or layer or intervening elements or layers, and criteria for “on” and “under” will be provided based on the drawings.

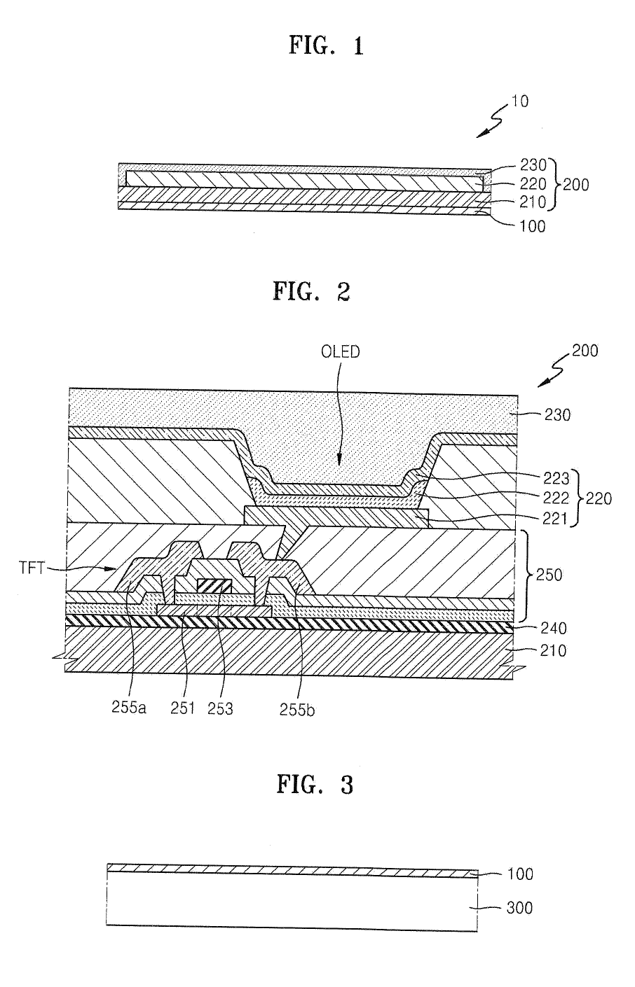

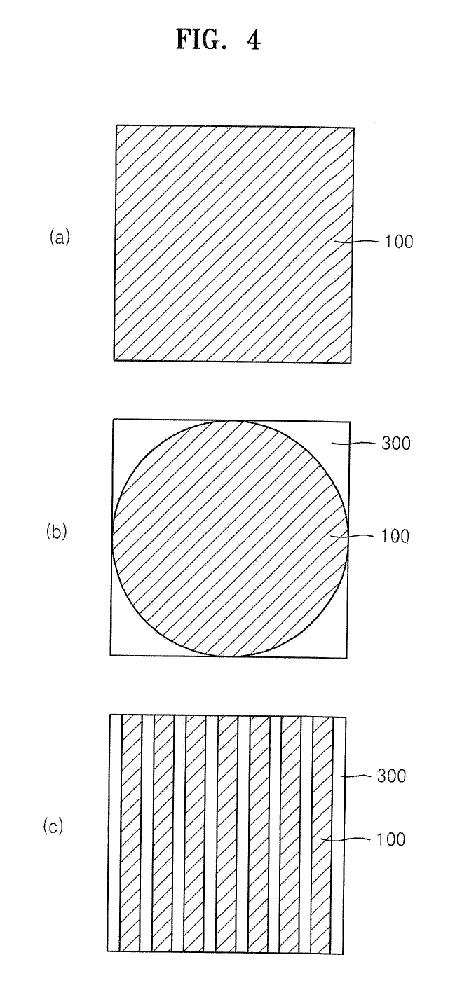

FIG. 1 is a schematic cross-sectional view of a flexible display apparatus 10 according to an embodiment of the present invention, and FIG. 2 is a schematic cross-sectional view of one pixel region of a display panel unit 200 of the flexible display apparatus 10 illustrated in FIG. 1.

Referring to FIGS. 1 and 2, the flexible display apparatus 10 according to the current embodiment may include the display panel unit 200 and a conductive layer 100 formed on a second substrate surface of the display panel unit 200, the display panel substrate having a first substrate surface interfacing with a light-emitting display unit and a second substrate surface opposite to the first substrate surface.

The display panel unit 200 has flexible characteristics and thus may be folded or rolled. Thus, the display panel unit 200 may have excellent storage capability and excellent portability. The display panel unit 200 may be an organic light-emitting display panel, a liquid crystal display (LCD) panel, or the like. However, aspects of the present invention are not limited thereto. FIG. 2 illustrates an organic light-emitting display panel as an example of the display panel unit 200.

Referring to FIG. 2, the display panel unit 200 may include a substrate 210, a light-emitting display unit 220 that is disposed on a first surface of the substrate 210, and an encapsulation layer 230 that is disposed on the light-emitting display unit 220 and encapsulates the light-emitting display unit 220. In one embodiment, the light-emitting display unit 220 is disposed between the encapsulation layer 230 and the first surface of the substrate 210. In addition, a barrier layer 240 and a device and wiring layer 250 can be formed between the substrate 210 and the light-emitting display unit 220.

The substrate 210 can be formed of a plastic material, such as acryl, polyethyleneterephthalate (PET), polyethylenenaphthalate (PEN), polycarbonate (PC), polyarylate (PAR), polyetherimide (PEI), polyethersulphone (PES), polyester, mylar, polyimide, or the like, so as to have flexible characteristics. However, aspects of the present invention are not limited thereto, and the substrate 210 may be formed of various materials.

The barrier layer 240 may be disposed on the substrate 210. The barrier layer 240 serves to prevent external foreign substances, such as moisture or oxygen, from permeating into the substrate 210 and diffusing into a driving thin film transistor (TFT) and/or the light-emitting display unit 220.

The device/wiring layer 250 can be disposed on the barrier layer 240 and can include a driving TFT for driving the light-emitting display unit 220, which can be referred to as an organic light-emitting diode (OLED), a switching TFT (not shown), a capacitor (not shown), and wirings connected to the above-described TFT's or the capacitor.

The driving TFT includes an active layer 251, a gate electrode 253, a source electrode 255a, and a drain electrode 255b.

The light-emitting display unit 220 is disposed on the device/wiring layer 250. The light-emitting display unit 220 includes a pixel electrode 221, an organic light-emitting layer 222 that is disposed on the pixel electrode 221, and an opposite electrode 223 that is formed on the organic light-emitting layer 222.

In a first embodiment, the pixel electrode 221 is an anode, and the opposite electrode 223 is a cathode. However, aspects of the present invention are not limited thereto, and, in other embodiments, the pixel electrode 221 can be a cathode, and the opposite electrode 223 can be an anode, depending on the way in which the display panel unit 200 is driven. In this first embodiment, holes and electrons are injected into the organic light-emitting layer 222 from the pixel electrode 221 and the opposite electrode 223, respectively. When excitons, which are formed by combining the injected holes and electrons, drop to a ground state from an excited state, the organic light-emitting layer 222 emits light.

The pixel electrode 221 is electrically connected to the driving TFT formed on the device/wiring layer 250.

In this first embodiment, the light-emitting display unit 220 is disposed on the device/wiring layer 250 in which the driving TFT is disposed. However, aspects of the present invention are not limited thereto, and the light-emitting display unit 220 can be modified in various shapes, such as a structure in which the pixel electrode 221 of the light-emitting display unit 220 is formed from the same layer as the active layer 251 of the driving TFT, a structure in which the pixel electrode 221 of the light-emitting display unit 220 is formed from the same layer as the gate electrode 253 of the driving TFT, or a structure in which the pixel electrode 221 of the light-emitting display unit 220 is formed from the same layer as the source electrode 255a and the drain electrode 255b of the driving TFT,

In addition, in this first embodiment, the gate electrode 253 of the driving TFT is disposed above the active layer 251. However, aspects of the present invention are not limited thereto, and the gate electrode 253 of the driving TFT can be disposed under the active layer 251.

The pixel electrode 221 of the light-emitting display unit 220 according to the current embodiment may be a reflective electrode including a reflective layer formed of Ag, Mg, Al, Pt, Pd, Au, Ni, Nd, Ir, Cr, and a compound thereof, and a transparent or semi-transparent electrode layer formed on the reflective layer.

The transparent or semi-transparent electrode layer may include at least one selected from the group consisting of indium tin oxide (ITO), indium zinc oxide (IZO), zinc oxide (ZnO), indium oxide (In₂O₃), indium gallium oxide (IGO), and aluminum zinc oxide (AZO).

The opposite electrode 223 facing the pixel electrode 221 may be a transparent or semi-transparent electrode and may be formed as a metal thin layer formed of metal having a small work function, such as Li, Ca, LiF/Ca, LiF/Al, Al, Ag, Mg, and a compound thereof. In addition, an auxiliary electrode layer or bus electrode may be further formed of a transparent electrode-forming material, such as ITO, IZO, ZnO, In₂O₃, or the like, on the metal thin layer. Thus, the opposite electrode 223 enables light emitted from the organic light-emitting layer 222 to transmit through the opposite electrode 223.

The organic light-emitting layer 222 is disposed between the pixel electrode 221 and the opposite electrode 223. The organic light-emitting layer 222 can be a low molecular weight organic material, or a polymer organic material.

An intermediate layer, such as a hole transport layer (HTL), a hole injection layer (HIL), an electron transport layer (ETL), and an electron injection layer (EIL), as well as the organic light-emitting layer 222 can be selectively disposed between the pixel electrode 221 and the opposite electrode 223.

The display panel unit 200 of the flexible display apparatus 10 can be a top-emission type panel unit in which light emitted from the organic light-emitting layer 222 is reflected directly or by the pixel electrode 221 formed as the reflective electrode and is emitted in a direction of the opposite electrode 223.

However, the display panel unit 200 according to the present invention is not limited to being a top-emission type panel unit and can also be a bottom-emission type panel unit in which light emitted from the organic light-emitting layer 222 is emitted in a direction of the substrate 210. In this case, the pixel electrode 221 can be a transparent or semi-transparent electrode, and the opposite electrode 223 can be a reflective electrode.

The encapsulation layer 230 can be disposed on the opposite electrode 223. The encapsulation layer 230 can be an organic layer formed to have a multi-layer structure or can be formed as a thin layer including an inorganic layer and an organic layer. The encapsulation layer 230 performs a function of preventing external moisture, oxygen, or the like, from permeating into the light-emitting display unit 220.

The conductive layer 100 is formed on a second substrate surface, which is opposite to the first substrate surface of the substrate 210. The conductive layer 100 includes at least one conductor selected from a carbon nanotube (CNT), a fullerene, and a nanowire. Because the individual conductor structures overlap and are in electrical contact with each other, conductivity is uninterrupted across all dimensions of the conductive layer 100. Because the carbon nanotube (CNT) or the like has a large aspect ratio, even though the conductive layer 100 has a small thickness, a conductive line that crosses the substrate 210 can be formed without any interruption.

In addition, the conductive layer 100 may be grounded on a frame (not shown) that encompasses the display panel unit 200 and the conductive layer 100. Thus, even when static electricity is generated in portions of the substrate 210, static electricity may be effectively removed from the substrate 210 via the conductive layer 100, and thus electrical characteristics of the driving TFT may be prevented from being changed due to static electricity. Furthermore, the conductive layer 100 may prevent oxygen and moisture from permeating into the display panel unit 200 via the substrate 210, which can be formed of plastics having a low tolerance to oxygen and moisture.

The conductive layer 100 may have a thickness of 10 to 30 μm. When the thickness of the conductive layer 100 is larger than 30 μm, flexible characteristics of the flexible display apparatus 10 may be diminished. When the thickness of the conductive layer 100 is smaller than 10 μm, the conductivity of the conductive layer 100 is insufficient and thus charges accumulated on the substrate 210 may not be effectively removed from the substrate 210. Thus, the conductive layer 100 can have a thickness of from 10 to 30 μm.

In addition, the content of the conductor, such as a CNT, or the like, in the conductive layer 100 may be 5 to 10 wt %.

When the content of the conductor, such as a CNT, or the like, is less than 5 wt %, the conductivity of the conductive layer 100 is insufficient and thus charges accumulated on the substrate 210 may not be effectively removed from the substrate 210. On the other hand, when the content of the conductor, such as a CNT, is greater than 10 wt %, the conductive layer 100 is not formed to a uniform thickness and thus the flexible characteristics of the display panel unit 200 may be lowered.

Table 1 below shows the result of measuring values of charges accumulated on the substrate 210 when the conductive layer 100 is formed in the flexible display apparatus 10 according to the present invention and when the conductive layer 100 is not formed in a flexible display apparatus according to the related art, respectively. In detail, Table 1 shows the result of measuring values of static electricity at a point that is opposite to a point where static electricity is induced, after static electricity has been induced at one vertex of the flexible display apparatus 10 by using an electrostatic gun.

TABLE 1

| Induced static | Measured | Measured values |
|---|---|---|
| electricity | values in first | according to |
| value | embodiment | comparative example |
| 2 KV | 1.7 to 2 KV | 0 KV |

As shown in Table 1, according to a comparative example in which the conductive layer 100 is not formed, measured values of static electricity are 0 KV, whereas, in an embodiment of the present invention in which the conductive layer 100 is formed, measured values of static electricity are between 1.7 KV and 2 KV. That is, when the conductive layer 100 is formed according to the present invention, charges accumulated on the substrate 210 may be easily discharged to the outside via the conductive layer 100. Thus, electrical characteristics of the driving TFT may be prevented from being changed due to static electricity.

Although not shown, a silane derivative layer (not shown) having conductivity may be further formed on a second surface of the conductive layer 100, the conductive layer 100 having a first surface that interfaces with the substrate 210 and a second surface that is opposite to the first surface. The silane derivative layer may be formed of a silicon compound having a sulfhydryl group (—SH) as a substituent.

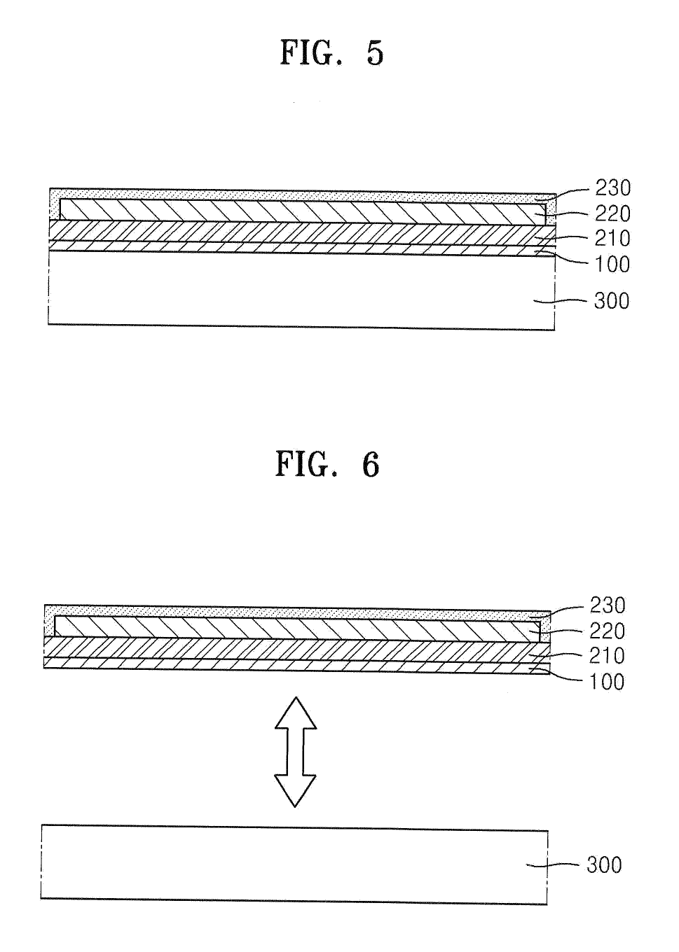

Since the silane derivative layer has conductivity, static electricity generated in portions of the substrate 210 may be effectively removed from the substrate 210, and, as described below, a carrier substrate (see 300 of FIG. 3) may be more easily separated from the substrate 210. That is, when the carrier substrate (see 300 of FIG. 3) is separated from the substrate 210 by using a physical method, relatively weak noncovalent interactions with sulfhydryl groups (—SH) of the silane derivative layer (not shown) are severed, and the carrier substrate (see 300 of FIG. 3) can be easily separated from the substrate 210.

FIGS. 3 through 6 are cross-sectional views illustrating a method of manufacturing the flexible display apparatus 10 of FIG. 1, according to an embodiment of the present invention.

Hereinafter, the method of manufacturing the flexible display apparatus 10 of FIG. 1, according to an embodiment of the present invention, will be described with reference to FIGS. 3 through 6.

First, as illustrated in FIG. 3, a conductive layer 100 is formed on a carrier substrate 300.

The carrier substrate 300 is formed of material having heat resistance, such as glass or the like. In addition, the mechanical strength of the carrier substrate 300 is sufficient to facilitate the manufacture of flexible display apparatus 10 by attaching each element or layer in succession. Even when all of the various elements or layers of flexible display apparatus 10 are put in place, the carrier substrate 300 remains functional, intact, and physically and chemically unchanged.

The conductive layer 100 can be formed by applying a solution, in which a conductor, such as a CNT, fullerene, a nanowire, or the like, is dissolved in an organic solvent, onto the carrier substrate 300 by using spin coating, dip coating, slit coating, or the like and by then drying and firing the applied solution.

Here, the solvent may be a material in which conductors such as CNT's or the like have high solubility. For example, the solvent may be i) an aliphatic hydrocarbon solvent, such as hexane, heptane, or the like, an aromatic hydrocarbon solvent, such as pyridine, mesitylene, or the like, ii) a ketone-based solvent, such as methyl isobutylketone, cyclohexanone, acetone, or the like, iii) an ether-based solvent, such as isopropyl ether, or the like, or iv) an ester solvent, such as ethyl acetate, butyl acetate, or the like. However, aspects of the present invention are not limited thereto, and a silicon-based solvent, an amide-based solvent, or the like can also be used.

In addition, the conductive layer 100 can be formed by applying a paste including a conductor, such as a CNT, glass frit, a binder, a solvent, and the like, onto the carrier substrate 300.

Here, the glass fit may be one selected from a SiO₂—PbO-based powder, a SiO₂—PbO—B₂O₃-based powder, and a Bi₂O₃—B₂O₃—SiO₂-based powder, or a compound of two or more of the above-described powders; however, aspects of the present invention are not limited thereto.

The binder functions to facilitate the mixture of the components before the paste is fired. For example, the binder may be one selected from cellulose, butyl carbitol, and terpineol, or a compound of two or more of the above-described materials; however, aspects of the present invention are not limited thereto.

The solvent can dissolve the binder and can be mixed well with other additives. For example, the solvent can include a surfactant alcohol, such as α-terpinol, butyl carbitol acetate, texanol, butyl carbitol, di-propylene glycol monomethyl ether, and the like; however, aspects of the present invention are not limited thereto.

The paste may be printed using a screen printing method whereby a screen mask is located and a squeegee is moved so as to perform printing of the paste, for example.

In addition, the conductive layer 100 can be formed directly on the carrier substrate 300 by using chemical vapor deposition (CVD) or the like, or can be formed by laminating a film including a conductor, such as a CNT or the like, and by attaching the film onto the carrier substrate 300.

FIGS. 4A through 4C illustrate various shapes of the conductive layer 100 to be formed. The conductive layer 100 can be formed on the entire surface of the carrier substrate 300, as illustrated in FIG. 4A, or can be formed to have a circular shape, as illustrated in FIG. 4B. In addition, the conductive layer 100 can be formed to have a plurality of stripe patterns arranged in parallel, as illustrated in FIG. 4C. Unlike this, although not shown, the conductive layer 100 can be formed to have a plurality of lattice patterns.

However, the lattice patterns do not interrupt the conductivity of conductive layer 100 as measured from one corner of conductive layer 100 on substrate 210 to an opposite corner of the conductive layer 100 on substrate 210. Thus, when static electricity is generated in any portion of the substrate 210, the static electricity can be effectively removed from the substrate 210 via the conductive layer 100.

Although not shown, a silane derivative layer (not shown) having conductivity can be formed on the carrier substrate 300 before the conductive layer 100 is formed. The silane derivative layer can be formed by applying a solution in which a silicon compound having a substituent including a sulthydryl group (—SH) is dissolved in an alcohol-based solvent, such as ethanol, methanol or the like, onto the carrier substrate 300 and by drying the applied solution.

Subsequently, the substrate 210, the light-emitting display unit 220, and the encapsulation layer 230 are sequentially formed on the conductive layer 100, as illustrated in FIG. 5.

The substrate 210 can be formed of a plastic material, such as an acrylic polymer, polyethyleneterephthalate (PET), polyethylenenaphthalate (PEN), polycarbonate (PC), polyarylate (PAR), polyetherimide (PEI), polyethersulphone (PES), polyester, mylar, polyimide, or the like, so as to have flexible characteristics.

A pixel electrode (see 221 of FIG. 2), an organic light-emitting layer (see 222 of FIG. 2), and an opposite electrode (see 223 of FIG. 2) are sequentially formed on the substrate 210 to form the light-emitting display unit 220, and the encapsulation layer 230 is formed on the light-emitting display unit 220 so as to cover the light-emitting display unit 220. The encapsulation layer 230 may be an organic layer formed to have a multi-layer structure, or a thin layer including an inorganic layer and an organic layer.

Subsequently, the carrier substrate 300 is separated from the substrate 210, as illustrated in FIG. 6.

The carrier substrate 300 can be separated from the substrate 210 by using a physical method. That is, according to the present invention, the carrier substrate 300 can be easily separated from the substrate 210 by controlling an adhesion force between the carrier substrate 300 and the conductive layer 100 and an adhesion force between the conductive layer 100 and the substrate 210, instead of irradiating laser onto the carrier substrate 300, as in the related art. For example, the adhesion force between the substrate 210 and the conductive layer 100 can be greater than the adhesion force between the carrier substrate 300 and the conductive layer 100.

Thus, static electricity that is generated between the carrier substrate 300 and the substrate 210 when laser is irradiated onto the carrier substrate 300 so as to separate the carrier substrate 300 from the substrate 210, as in the related art, can be prevented, and a yield for detaching the carrier substrate 300 from the flexible display apparatus (see 10 of FIG. 1) can be improved.

In addition, as described above, when a silane derivative layer (not shown) having conductivity is formed between the conductive layer 100 and the carrier substrate 300 and the carrier substrate 300 is separated from the substrate 210 by using a physical method, a substituent including a sulfhydryl group (—SH) of the silane derivative layer is severed from the carrier substrate 300, remaining with conductive layer 100, and the carrier substrate 300 may be more easily separated from the substrate 210 than would be possible without silane derivative treatment of carrier substrate 300 prior to assembling flexible display apparatus 10.

Table 2 below shows the result of measuring the amount of static electricity that is generated when the carrier substrate 300 is separated from the substrate 210 when the conductive layer 100 is not present, by irradiating laser onto the carrier substrate 300, as in the related art, according to a comparative example, and the result of measuring the amount of static electricity that is generated when the carrier substrate 300 is removed from the substrate 210 by using a physical method, according to an embodiment of the present invention, respectively.

TABLE 2

| | | Comparative |
|---|---|---|
| | Embodiment | example |
| Measured values | 0.2 to 0.5 KV | 2 to 10 KV |
| of static | | |
| electricity | | |

As shown in Table 2, when the carrier substrate 300 is removed from the substrate 210 by using a physical method according to the present invention, generation of static electricity may be effectively reduced.

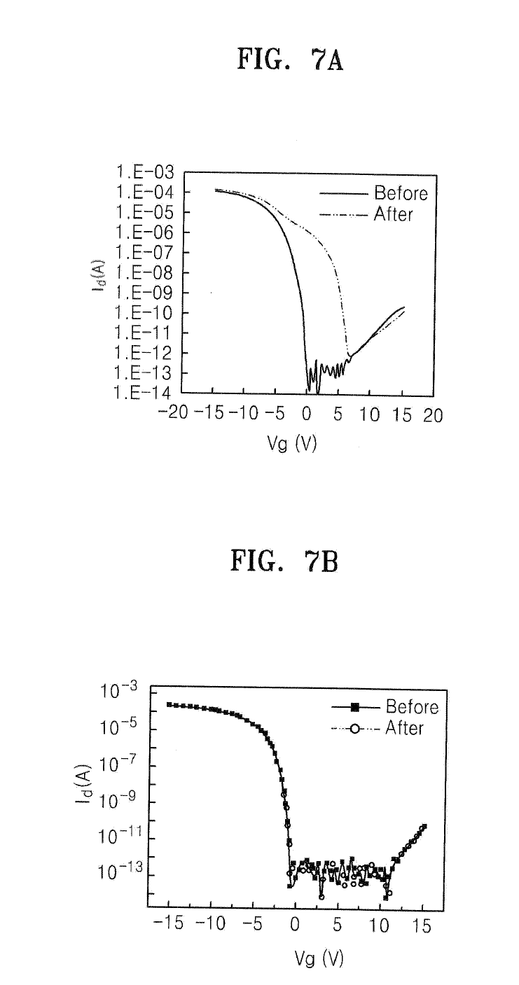

FIGS. 7A and 7B are graphs showing voltage transfer curves before and after the carrier substrate (see 300 of FIG. 3) is detached from the flexible display apparatus (see 10 of FIG. 1), respectively. In detail, FIG. 7A shows the result of manufacturing the flexible display apparatus 10 of FIG. 1 in the same manner as that of the comparative example in Table 2, and FIG. 7B shows the result of manufacturing the flexible display apparatus 10 of FIG. 1 in the same manner as that of the embodiment in Table 2.

As shown in FIG. 7A, when the carrier substrate 300 is removed from the substrate (see 210 of FIG. 1) by irradiating laser onto the carrier substrate 300, as in the related art, static electricity is generated between the carrier substrate 300 and the substrate 210, as shown in Table 2. As a result, electrical characteristics of the flexible display apparatus 10 of FIG. 1 are changed such as changing a polarity of a voltage Vg of the driving TFT into a positive polarity, whereas, according to the present invention, the voltage transfer curves are hardly changed before and after the carrier substrate 300 is detached from the flexible display apparatus 10 of FIG. 1.

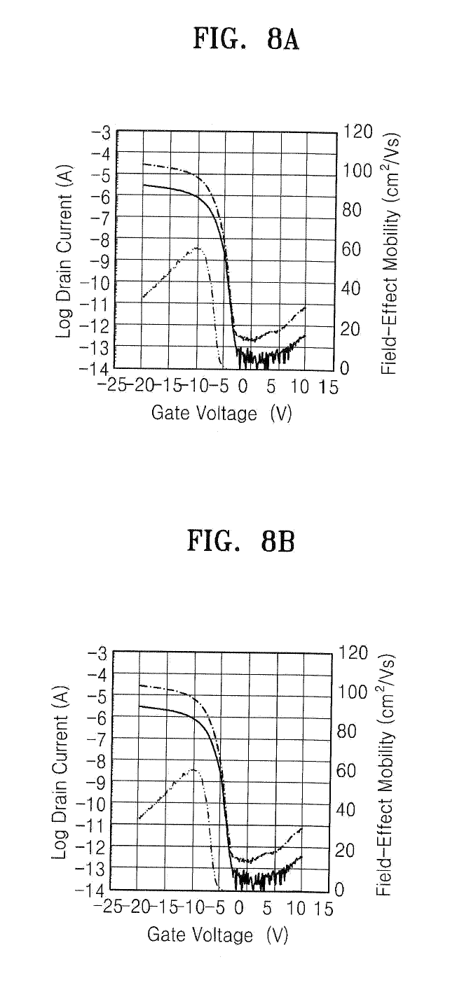

FIGS. 8A and 8B are graphs showing voltage transfer curves of the flexible display apparatus 10 of FIG. 1. In detail, FIG. 8A shows a voltage transfer curve before the carrier substrate 300 is detached from the flexible display apparatus 10 of FIG. 1, and FIG. 8B shows a voltage transfer curve after the carrier substrate 300 is detached from the flexible display apparatus 10 of FIG. 1.

In addition, the following Table 3 shows the result of measuring a voltage Vth, mobility, and an S factor of FIGS. 8A and 8B, respectively.

TABLE 3

| | | Mobility | S factor |
|---|---|---|---|
| | Vth(V) | (cm²/Vs) | (V/dec) |
| (a) | −5.7 | 62.3 | 0.4 |
| (b) | −5.8 | 62.3 | 0.4 |

As shown in Table 3 and FIG. 8, the flexible display apparatus according to the present invention may prevent changes in characteristics of a light-emitting display unit due to static electricity.

According to an embodiment of the present invention, a conductive layer is formed on one surface of a light-emitting display unit so that changes in characteristics of the light-emitting display unit due to static electricity can be prevented.

The structure of a flexible display apparatus according to an embodiment of the present invention and a method of manufacturing the flexible display apparatus according to an embodiment of the present invention is not limited thereto, and the whole or parts of embodiments of the present invention may be selectively combined so as to implement various modifications.

While the present invention has been particularly shown and described with reference to exemplary embodiments thereof, it will be understood by those of ordinary skill in the art that various changes in form and details can be made therein without departing from the spirit and scope of the present invention as defined by the following claims.

What is claimed is:

1. A flexible display apparatus comprising:
a substrate having a first substrate surface and a second substrate surface opposite to the first substrate surface;
a light-emitting display unit formed on the first substrate surface;
an encapsulation layer formed on the light-emitting display unit; and
a conductive layer formed on the second substrate surface, the conductive layer comprising a conductor, the conductor comprising at least one of a carbon nanotube (CNT), a fullerene, and a nanowire.

2. The flexible display apparatus of claim 1, conductivity being uninterrupted across all dimensions of the conductive layer.

3. The flexible display apparatus of claim 1, the conductive layer having a thickness of 10 to 30 μm.

4. The flexible display apparatus of claim 1, the content of the conductor in the conductive layer being 5 to 10 wt %.

5. The flexible display apparatus of claim 1, the conductive layer having a first conductive layer surface and a second conductive layer surface opposite to the first conductive layer surface, the first conductive layer surface facing the second substrate surface, the flexible display apparatus further comprising a silane derivative layer having conductivity and disposed on the second conductive layer surface.

6. The flexible display apparatus of claim 1 having a device and wiring layer formed between the substrate and the light-emitting display unit.

7. The flexible display apparatus of claim 1 the light-emitting display unit comprising an organic light-emitting display panel.

8. A method of manufacturing a flexible display apparatus, the method comprising:
providing a carrier substrate;
providing a conductive material;
providing a substrate composition, the substrate composition comprising one or more substrate composition components, the substrate composition being capable of forming a substrate layer;
providing an organic light-emitting composition, a pixel electrode composition, and an opposite electrode composition;
providing an encapsulation composition, the encapsulation composition comprising one or more encapsulation composition components;
using the conductive material to form a conductive layer on the carrier substrate;
using the substrate composition to form a substrate on the conductive layer;
forming a light-emitting display unit on the substrate, the forming step comprising:
using the pixel electrode composition to form a pixel electrode layer;
using the organic light-emitting composition to form an organic light-emitting layer; and
using the opposite electrode composition to form an opposite electrode layer;
using the encapsulation composition to form an encapsulation layer on the light-emitting display unit; and
removing the carrier substrate from the substrate,
the conductive material comprising a conductor, the conductor comprising at least one of a carbon nanotube (CNT), a fullerene, and a nanowire.

9. The method of claim 8, the step of using the conductive material to form a conductive layer comprising:
forming the conductive layer by applying a solution comprising the-conductor onto the carrier substrate;
drying the applied solution; and
firing the applied solution.

10. The method of claim 8, the step of using the conductive material to form a conductive layer comprising:
forming a paste comprising the conductor, glass frit, a binder, and a solvent; and
forming the conductive layer on the carrier substrate by using a screen printing method.

11. The method of claim 8, the step of removing the carrier substrate from the substrate comprising removing the carrier substrate from the substrate using a physical method.

12. The method of claim 8, the conductive layer having a thickness of 10 to 30 μm.

13. The method of claim 8, the content of the conductor in the conductive layer being 5 to 10 wt %.

14. The method of claim 8, conductivity being uninterrupted across all dimensions of the conductive layer.

15. The method of claim 8, an adhesion force between the substrate and the conductive layer being greater than an adhesion force between the carrier substrate and the conductive layer.

16. The method of claim 8, the method further comprising providing a silane derivative having conductivity, the step of using the conductive material to form a conductive layer on the carrier substrate further comprising using the silane derivative to form an underlying silane derivative layer on the carrier substrate.
